(19) United States
(12) Patent Application Publication
(10) Pub. No.: US 2008/0228346 A1
(43) Pub. Date: Sep. 18, 2008

(54) Apparatus, systems and methods for managing vehicle assets

(76) Inventors: Michael Lucas, Rancho Santa Fe, CA (US); Gerardo Flores, Pasadena, CA (US)

Correspondence Address: NATH & ASSOCIATES, 112 South West Street, Alexandria, VA, 22314, US

(21) Appl. No.: 12/073,575

(22) Filed: Mar. 6, 2008

Related U.S. Application Data
(63) Continuation-in-part of application No. 10/873,183, filed on Jun. 23, 2004.
Application No. 10/873,183 is a continuation of application No. 09/799,879, filed on Mar. 7, 2001, now Pat. No. 6,996,538.
(60) Provisional application No. 60/187,389, filed on Mar. 7, 2000.
(60) Provisional application No. 60/905,046, filed on Mar. 6, 2007.

(51) Int. Cl. G01M 17/00

(52) U.S. Cl. 701/33

(57) ABSTRACT

The inventive subject matter relates to an apparatus, systems, methods, and computer program products relating to tracking and managing vehicle assets. More particularly, the invention relates, preferably, to using wireless systems to track and manage vehicle assets, vehicle inventory, parts inventory, parts and/or equipment installed on said asset, a vehicle operator, a vehicle owner, or a combination thereof.

This application is a continuation-in-part of U.S. patent application Ser. No. 10/873,183, filed Jun. 23, 2004, which is a continuation of U.S. patent application Ser. No. 09/799,879, filed Mar. 7, 2001, now U.S. Pat. No. 6,998,538, which claims the benefit of U.S. Provisional Patent Application No. 60/187,389, filed Mar. 7, 2000, the contents of which are hereby incorporated by reference in their entirety. Further, this application claims the benefit of U.S. Provisional Patent Application No. 60/905,046, filed Mar. 6, 2007, the contents of which is hereby incorporated by reference in its entirety.

### BACKGROUND OF THE INVENTIVE SUBJECT MATTER

1. Field of Inventive Subject Matter

The inventive subject matter relates to an apparatus, systems, methods, and computer program products relating to tracking and managing vehicle assets. More particularly, the invention relates, preferably, to using wireless systems to track and manage vehicle assets, vehicle inventory, parts inventory, parts and/or equipment installed on said asset, a vehicle operator, a vehicle owner, or a combination thereof.

2. Background

Asset management is critical in today's enterprises and government agencies in order to streamline operations and reduce overall operation costs. However, currently there are few tools available that allow enterprises or government agencies to accurately track, manage, or maintain, vehicle assets including vehicle inventory, parts inventory, parts and equipment installed on said vehicles, and the owners and operators of said vehicles. Many enterprises and government agencies spend a considerable amount on installing specialized equipment or capital assets on vehicles, but have few options available to track and manage their vehicle assets and ensure that their resources are being used as efficiently as possible.

Many enterprises and government agencies manage vehicle service and maintenance. A problem which occurs in this regard is that efficiently managing vehicles requires asset location identification, as many enterprises and government agencies have a plurality of sites and vehicles, and in many instances, the whereabouts of vehicle assets are not known absent taking a costly and time-consuming physical inventory.

Another common problem commonly felt in many automotive dealerships, enterprises, or government agencies, is that vehicles arrive for service, maintenance, and/or repair, while employees arrive at the beginning and depart at the end of a scheduled shift, in each case often without accurate accounting and management; to remedy this deficiency requires staff or vehicle operator attention and time, which detracts from other responsibilities. Incomplete or inaccurate records of such processes may be created; information details regarding a vehicle are often not recorded at all, recorded inaccurately, or recorded incompletely.

Further, many enterprises and government agencies would benefit from reducing the amount of vehicle parts maintained on hand and in stock, to be available for replacement to their fleet vehicles. It would better define the parts or supplies inventory needed to be on hand if records were kept and decisions could be based, for example, on life expectancy of the vehicle assets or parts tracked, along with maintenance records of the enterprise or government agency. As technology continues to advance, one goal of such enterprises and government agencies is to keep minimal inventory in stock for repair, backup, and/or replacement, thereby reducing the capital devoted to maintaining unproductive inventory and assets.

Finally, many enterprises and government agencies experience the problem of only reacting to repair or replacement needs, instead of preventative maintenance. If the information about vehicle assets, as discussed above, was accessible, particularly if easily accessible via a software business application, in advance of a service or maintenance issue, such enterprises would be able to maintain more accurate budgets, would be able to submit accurate and complete information to enterprise or government finance managers, and would be able to more accurately stock needed parts, service and maintenance items, and supplies.

With such vehicle asset information, vehicle sales, maintenance, and repair enterprises, including government agencies, would also be able to improve their forecasts because their finance departments/managers would have a better idea of the parts and equipment requirements necessary for the upcoming month(s) or year(s). And finally, the enterprise would be able to reduce inventory, better predict inventory usage, and more efficiently order special order items that may otherwise take additional time to obtain, and might thus prevent a vehicle asset from being out of use for an extended period of time.

Thus, there is a particular need for systems, methods, apparatus, and computer program products to better track and manage mobile and portable assets of an enterprise, such as vehicles.

Thus, with improvements in wireless technology, there is a particular need for systems, methods, apparatus, and computer program products to better track and manage vehicles, vehicle inventory, installed equipment, parts inventory, and vehicle owners and operators of an enterprise or government agency.

### SUMMARY OF THE INVENTIVE SUBJECT MATTER

The inventive subject matter relates to an apparatus for collecting information regarding a vehicle, a part thereof, or an owner or operator thereof, comprising a wireless device attached to said vehicle or part thereof, and an interface operably connected to said wireless device and connected to a vehicle electronic control unit; a reading unit wherein said reader reads vehicle information from the vehicle electronic control unit and said interface wirelessly transmits said information to an interface receiver within transmission range from said interface.

The inventive subject matter further relates to systems and related methods for managing vehicles, comprising the steps of:

providing a wireless device connected to the electronic control unit of a vehicle and capable of collecting vehicle information from said electronic control unit and transmitting said information;

collecting information regarding said vehicle from said electronic control unit;

transmitting said vehicle information to a reader, host computer, mobile handheld computer, or ELS within transmission range from said wireless device;

processing said vehicle information in one or more inventory database systems, wherein said inventory database system stores said vehicle information in a database;

permitting access to said vehicle information database to a plurality of authorized system users;

tracking the movement of said vehicle via one or more readers; and

managing a vehicle service or maintenance event based on said vehicle information.

### DETAILED DESCRIPTION OF THE INVENTIVE SUBJECT MATTER

### Definitions

“Capital asset” or “fixed asset” as used herein refers to a class of property, including durable goods, vehicles, equipment, buildings and land.

“Managed asset” as used herein refers to a class of assets, including “capital assets,” and encompasses durable goods, including vehicles.

“Tagged asset” as used herein refers to a managed asset to which is affixed a tag associated with an identifier which is unique to the asset.

Exemplary tags according to the present invention include, without limitation, bar code, radio frequency (RF) wireless, and newer technologies such as IEEE standard 1902.1, which is also known as RuBee. Thus, at least four different kinds of wireless RF tags are commonly used today. They are categorized by their radio frequency according to the following:
low-frequency tags (between 125 kHz to 134 kHz),
high-frequency tags (13.56 MHz),
ultra-high frequency (UHF) tags (868 MHz to 956 MHz), and
microwave tags (2.45 GHz).

RFID tags can be further classified as either active or passive. An active RFID tag requires its own power source, for example a battery, to operate, whereas passive RFID tags are powered by the signal generated from the reader device. With no on-board power supply, passive tags are oftentimes quite small and are becoming increasingly inexpensive.

Passive tags have practical read ranges that vary from about 10 mm up to about 6 meters. In contrast, active RFID tags have practical ranges of tens of meters, and a battery life of up to several years. They also have longer ranges and larger memories than passive tags, as well as the ability to store additional information sent by a transceiver.

Because passive tags are much cheaper to manufacture and do not depend on a battery, the majority of RFID tags on the market are passive in nature.

“Bluetooth” as used herein refers to an industrial specification for wireless personal area networks (PANs) developed and licensed by the Bluetooth Special Interest Group. Bluetooth provides a way to connect and exchange information between, for example, devices such as mobile phones, laptop computers, personal computers, printers, digital cameras, video game consoles, and other personal electronics over a secure, globally unlicensed short-range radio frequency network. However, the Bluetooth specification is not limited to personal electronic devices.

“Wireless USB” as used herein refers to a short-range, high-bandwidth wireless radio communication protocol created by the Wireless USB Promoter Group.

Bluetooth, along with wireless USB, provide short-range connectivity in a personal-area network. Bluetooth serves a short-range, moderate-speed, wire replacement technology. Wireless USB provides short-range, high-speed device connectivity.

Regarding other similar technologies, “Wi-Fi” as used herein refers to a wireless-technology brand owned by the Wi-Fi Alliance, and which promotes standards with the aim of improving the interoperability of wireless local area network (LAN) products based on the IEEE 802.11 standards. Common applications for Wi-Fi include Internet and VoIP phone access, gaming, and network connectivity for consumer electronics such as televisions, DVD players, and digital cameras.

Both wireless Ethernet (802.11b), otherwise known as Wi-Fi, and Bluetooth operate in the unlicensed 2.4 GHz industrial, scientific, and medical (ISM) band. This band is 83.5 MHz wide, beginning at 2.4 GHz and ending at 2.4835 GHz. Although the ISM band is unlicensed spectrum, the Federal Communications Commission (FCC) in the United States still regulates its use.

802.11 employs a direct-sequence, spread spectrum (DSSS) technology, while Bluetooth uses a frequency-hopping spread-spectrum (FHSS) technique. In relation to the sharing of the ISM band, see, for example, Oren Eliezer and Matthew Shoemaker, Bluetooth and Wi-Fi Coexistence Schemes Strive To Avoid Chaos, www.rfdesign.com, November 2001, the contents of which are hereby incorporated by reference herein in their entirety.

As in 802.11b networks, Bluetooth devices in a PAN also share the Bluetooth channel on a TDMA basis. However, in contrast to 802.11b, the Bluetooth channel is not fixed in frequency because frequency hopping is employed. Bluetooth devices hop in a pseudo-random manner among 79 defined channels spaced at 1 MHz distances (see FIG. 1b). In this way, Bluetooth occupies the entire band, but at any instant in time, only a small portion of the band is ever occupied. Bluetooth hops to a new channel in the ISM band about 1,600 times a second.

“WiMAX” as used herein refers to the Worldwide Interoperability for Microwave Access, which is a telecommunications technology aimed at providing wireless data over long distances in a variety of ways, from point-to-point links to full mobile cellular type access. It is based on the IEEE 802.16 standard, and is designed to provide wide-area networking (WAN) or metropolitan-area networking (MAN).

WiMAX is a standards-based technology enabling the delivery of last mile wireless broadband access as an alternative to wired broadband like cable and DSL. WiMAX provides fixed, nomadic, portable and, soon, mobile wireless broadband connectivity without the need for direct line-of-sight with a base station. In a typical cell radius deployment of three to ten kilometers, WiMAX Forum Certified™ systems can be expected to deliver capacity of up to 40 Mbps per channel, for fixed and portable access applications.

This is enough bandwidth to simultaneously support hundreds of businesses with T-1 speed connectivity and thousands of residences with DSL speed connectivity. Mobile network deployments are expected to provide up to 15 Mbps of capacity within a typical cell radius deployment of up to three kilometers. It is expected that WiMAX technology will be incorporated in notebook computers and PDAs by 2007, allowing for urban areas and cities to become “metro zones” for portable outdoor broadband wireless access.

“ZigBee” as used herein refers to a specification for a suite of high level communication protocols using small, low-power digital radios based on the IEEE 802.15.4 standard for wireless personal area networks (WPANs), such as wireless headphones connecting with cell phones via short-range radio. The technology is intended to be simpler and cheaper than other WPANs, and to compete with such alternatives as Bluetooth.

ZigBee is targeted at radio-frequency (RF) applications which require a low data rate, long battery life, and secure networking. Unlike Bluetooth or wireless USB devices, ZigBee devices have the ability to form a mesh network between nodes. Meshing is a type of daisy chaining from one device to another. This technique allows the short range of an individual node to be expanded and multiplied, covering a much larger area. One ZigBee network can contain more than 65,000 nodes (active devices). The network they form in cooperation with each other may take the shape of a star, a branching tree or a net (mesh). What's more, each node uses little power and each device can potentially operate for years off of a single AA cell.

ZigBee nodes can be used to tie an entire home, office or factory together for safety, security, and control. Nodes can be embedded in hundreds of sensors and controls that are built into sometimes quite large infrastructures for home automation, industrial automation, remote metering, automotives, medical equipment, patient monitoring, asset tracking systems, security systems, lighting and temperature control systems, and even toys.

There are three categories of ZigBee devices:
ZigBee Network Coordinator: a smart node that automatically initiates the formation of the network.
ZigBee Router: another smart node that links groups together and provides multi-hoping for messages. It is capable of associating with other routers and end-devices
ZigBee End Devices: sensors, actuators, monitors, switches, dimmers, and other controllers.

“Government Agency” as used herein refers to any federal, state, or local government agency exemplified without limitation by the U.S. Department of Defense, law enforcement at any level, and local fire departments.

“Enterprise” as used herein refers broadly to a purposeful or industrious undertaking. The term encompasses not only business undertakings, but also includes, for example, such non-business undertakings as managing the assets of a family or a home.

“User” as used herein refers to a person, machine, or mechanized process which manipulates a managed asset or managed asset unit such as a vehicle.

“Biometric identification device” as used herein refers to a device which detects essentially unique biometric characteristics such fingerprints, retinal scans, genetic features, and so forth. A preferred biometric identification device of the present invention is a fingerprint capture device. Such a fingerprint reader preferably makes use of a holographic element, provides for a high contrast image, and rejects residual latent fingerprints that remain on the detector surface. Such a device preferably complies with the geometric image accuracy specified in appendix F of the Electronic Fingerprint Transmission Specification for the Criminal Justice Information services (CJIS), ISO 19794-2, and/or the requirements for ten-print slap capture requirements for the Department of Homeland Security (DHS).

### The Inventive Subject Matter

The inventive subject matter relates to systems, methods, apparatus, and computer program products relating to tracking and managing mobile capital assets, particularly vehicles. More particularly, the invention relates preferably to using a reader, host computer, mobile handheld computer, or ELS within transmission range from said wireless device, such as a radio frequency identification wireless device to track, manage, and maintain vehicle assets and radio frequency identification wireless tags to track and manage the vehicle operator or the inventory goods or equipment installed or stored on the vehicle in a enterprise or government agency having one or more facilities.

The inventive subject matter provides a solution to vehicle tracking and management. The implementation of a new system appears to be a limiting issue at present, as most companies do not want a change in the way they conduct their business unless the labor requirement is minimal and the return on investment is substantial enough to make an impact. A vehicle asset item affixed with a wireless interface device which can hold the information described herein provides an efficient and cost effective solution. It also provides for minimal labor interaction for tracking, for example when wireless readers/antennae are in place at each entry/exit on or around operating and storage facilities.

The technology available for tracking such assets optionally may or may not require traditional reader(s) to confirm the presence of the vehicle or other tagged item. In one embodiment, the connection is made a conventional tag and reader combination. In another embodiment, the connection is made via Bluetooth connection to a host computer that receives the information being transmitted. In yet another embodiment, Applicants' exterior location system (ELS) is a device that acts like a reader to locate a vehicle within a specific area of a dealership facility or fleet location. The ELS enables the user to locate the vehicle by designated zones such as showroom floor, service department, or new vehicle inventory.

Exterior Location Systems (ELS). Repeaters are normally used to increase Bluetooth range. Applicants use ELS instead to gather local Bluetooth unique addresses and, for example, data including vehicle VIN, battery status, and so forth within specified zone(s), and relay this information to a remote host computer. Applicants' ELS is scalable and can be configured to communicate, or not, with other ELS devices, as well as standard Bluetooth devices to determine vehicle locations on a site and to distinguish between multiple zones or cells over large coverage areas.

Function: Applicants' ELS is configured to operate using two high-end Bluetooth modules that collaborate with each other to relay pertinent vehicle data and maintain predetermined zone(s) using a radio communication system so there is no need for direct line of site. Such devices constantly maintain communication at a predetermined transmission rate as long as the unit is powered, for example by a vehicle, and within the specified transmission range dictated by the ELS settings, or in the absence of ELS settings, as dictated by a host computer.

The ELS system uses two Bluetooth modules, a Class 1 module and a Class 2 module, and are configured as ‘master’ and ‘slave’. The Class 1 ‘master’ module has a 100 mW (20 dBm) power output, which has a direct effect on the range capability of the module. The Class 2 ‘slave’ module has a much lower power output of 2.5 mW (4 dBm), and as one would expect, the reduction in power output reduces the transmission range of the module. In one embodiment, a 5V DC power supply circuit is required to power the modules. This can be either a rechargeable battery with suitable charging mechanism, or a disposable battery. It is contemplated that other power supplies and chargers, for example solar or wind powered, are within the scope of the present invention. There are several factors affecting the choice of the power supply, including the desired data duty cycle, Bluetooth range, and so forth.

The size of each coverage zone is defined by configuring the transmit power and receive sensitivity of the Class 2 ‘slave’ Bluetooth module. Since the Class 1 ‘master’ module will be transmitting data to the remote computer, this module is configured for maximum transmit power, range, and receive sensitivity. The effective range of the Class 2 ‘slave’ module is extended by connecting to the Class 1 ‘master’ transceiver, compared to a standard pure Class 2 network. This is accomplished by using the higher sensitivity and transmitter power of the Class 1 ‘master’ module.

The higher transmitter power of the Class 1 ‘master’ module allows higher power to be received by the Class 2 ‘slave’ module. Additionally, the higher sensitivity of the Class 1 ‘master’ module allows reception of much lower transmitted power of the Class 2 ‘slave’ module to effectively allow operation of the Class 2 ‘slave’ module at much Yonger ranges. To allow the modules to coexist, the modules are also programmed with unique configuration scripts which prevent one transmitter from jamming the other, among other features.

In one exemplary embodiment, a simple command is sent from the remote computer to the Class 1 ‘master’ module (within the ELS) to create a Bluetooth connection. Once the Bluetooth connection is established, the Class 1 ‘master’ module acts as a transparent bridge to the Class 2 ‘slave’ module. This allows the remote computer to communicate to the Class 2 ‘slave’ module directly enabling the remote host computer to send command(s) to the Class 2 module(s), for example instructing it to gather ‘responses’ from local devices in communication with the ELS. The local zone or cell can be configured to communicate with other devices within a range from several centimeters to up to 300 meters clear line of site by adjusting the sensitivity of the module to define the size of any particular zone.

Vehicle Asset Management. Many enterprise employees, because of concerns with security, sensitivity and equipment value, already have employee identification cards which allow accessibility to facilities and equipment based on their pre-determined roles or permissions granted by enterprise administration. These roles or permissions may require some record-keeping, and thus provide entry and exit reports, as well as some level of security, but such systems are not currently used in conjunction with vehicle asset tracking for inventory vehicle asset management as disclosed by Applicant herein.

In one aspect of the inventive subject matter, applications of wireless tracking technology are wide ranging and include detecting objects as they pass near to a sensor, uniquely identifying a specific tag, such as an electronic control unit, and associated vehicle asset, and placing data relating to the tag into a wireless reader for later recovery. The process of reading and communicating with an wireless interface device generally includes bringing the tag, such as an electronic control unit, in proximity to a wireless device sensor.

In another aspect of the inventive subject matter not involving a tag and reader, communications between, for example, ELS and/or Bluetooth devices can be established when the devices are within range of each other, and can be continuously or intermittently maintained.

In a further aspect, the wireless interface devices are electronic control units which emit a constant RF signal (or alternatively pulsed beacon). The wireless readers then detect the electronic control unit's emitted signal when the signal is within the range of the reader's receive range, and the readers receive and process the signal emitted by the tag, such as electronic control units. Thus, the reader detects the presence of a wireless interface device by detecting its signal, and processes the received signal to accurately determine the unique identification code of the tag, such as an electronic control unit.

Alternatively, in more conventional systems, the wireless interface devices are passive until activated by the radio frequency field of a wireless device sensor, at which point they become active. The wireless interface device detects the presence of the field of the reader, and subsequently activates to send data, using various forms or protocols of hand shake occur between the tag and the reader, in order to exchange data. All of this communication between a tag's transponder and a sensor is performed using radio frequency energy of some kind. When multiple wireless interface devices are involved, anti-collision protocols are employed in order to multiplex or provide multiple accesses to the readers by the multiple tags. The main advantages of a wireless device sensor and transponder system over the other forms of wireless tagging include (i) communication can occur within comparatively harsh operating environments; and (ii) the communication range between the sensor and transponder can be significant even when the RF frequencies are within the power limitations of the Federal Communications Commission (FCC) rules concerning unlicensed transmitters.

In a further aspect of the inventive subject matter, vehicle asset inventory and equipment on the vehicle can be compared to an inventory data server (IDS) database to alert management when the vehicle returns to the fleet facility and an expected item is not found on the vehicle, when such items were affixed with a tag and correspond to the wireless device on the vehicle, which also confirms the VIN of the vehicle and the identity of its operator. Optionally, the date, time, and other vehicle information can be recorded and notifications sent to a supervisor.

As each such vehicle asset item is removed from the warehouse, the inventive systems, methods, and/or software records both the date and time of exit, and employee information from the employee removing the item, either from an identification card or entry of the required data. If the employee removing the item is not permitted to do so, under enterprise administration rules, an electronic notification may, in one embodiment, be sent to a supervisor or other authority within the company. On the other hand, if the action is permitted, an electronic notification, such as a text message, may be sent to the employee requesting further information such as the destination for vehicle asset item(s) removed, which may be selected as all or individually, depending on number of locations the items are intended for.

Thereafter, in another embodiment, if the employee, does not respond to an inquiry, a report or event notification may be generated for a supervisor or other employee responsible for accounting for the vehicle asset.

In another aspect, the inventive systems, methods, software, and apparatus will function to direct employees to the location of an asset item scheduled for replacement, repair or maintenance. The specific location where the vehicle asset is stored may be found, for example, through a wireless device such as a telephone with wireless capabilities, which can locate the unique identifier associated with the vehicle asset. This will reduce the amount of time currently spent searching for equipment, or the location of items to be replaced or repaired.

Another benefit of the above procedure is that, for example, if an employee fails to input information required to be reported such as a destination code, the unique identifier tag would be read upon coming within range of the system, such as upon entry at the destination, and required information or event would be automatically recorded, accomplishing the same end as the physical act of the employee.

In an additional embodiment, an employee could also be made accountable for those vehicles, parts, and the like that are removed when no destination information is entered. Having such information automatically entered, raising the level of employee accountability, or both, would be expected to positively affect, for example, enterprise departments responsible for accounting and inventory control.

The inventive subject matter, particularly utilizing a wireless system network, provides a solution to vehicle and vehicle-related asset tracking and management. As discussed above, the implementation of a new system appears to be a limiting issue for at least some companies, which do not want a change in the way they conduct their business unless the labor requirement is minimal and the return on investment is substantial enough to make an impact. An asset item affixed with a wireless interface device which can hold the information described herein provides an efficient and cost effective solution to this barrier to acceptance. It also provides for minimal labor interaction for tracking, for example when wireless readers, antennae, or detectors are in place at various locations throughout a product sales or service facility.

### Inventive Apparatus

Thus, the inventive subject matter relates to an apparatus for collecting information regarding a vehicle, a part thereof, or an owner or operator thereof, comprising a wireless device attached to said vehicle or part thereof, and an interface operably connected to said wireless device and connected to a vehicle electronic control unit; a reading unit wherein said reader reads vehicle information from the vehicle electronic control unit and said interface wirelessly transmits said information to an interface receiver within transmission range from said interface.

In one aspect of the inventive subject matter, said wireless device is selected from the group consisting of a reader, a host computer, a mobile handheld computer, or an ELS.

In another aspect of the inventive subject matter, said interface and interface receiver operate according to one or more of wireless communications protocols selected from the group consisting of RFID, RuBee, Bluetooth, Wireless USB, Wi-Fi, WiMAX, and ZigBee.

In one embodiment, the inventive subject matter can apply to rental car agencies and go beyond to be applied to dealerships and fleet management companies or fleets within companies. Features of such an apparatus include a device connected to the vehicle ECU that wirelessly transmits data to a computer, portal reader, or ELS within a programmed distance. Key differences from existing technologies include:
vehicle management,
inventory management,
remote diagnostic services, and
automatic vehicle data information updated to a IDS,
   all accomplished utilizing mobile devices as the communication means.

### Inventive Methods

The inventive subject matter relates to a method for managing vehicles, comprising the steps of:

providing a wireless device connected to the electronic control unit of a vehicle and capable of collecting vehicle information from said electronic control unit and transmitting said information;

collecting information regarding said vehicle from said electronic control unit;

transmitting said vehicle information to a reader, host computer, mobile handheld computer, or ELS within transmission range from said wireless device;

processing said vehicle information in an inventory database system, wherein said inventory database system stores said vehicle information in a database;

permitting access to said vehicle information database to a plurality of authorized system users;

tracking the movement of said vehicle via one or more readers; and

managing a vehicle service or maintenance event based on said vehicle information.

Vehicle management. A wireless device is connected to the ECU. Information (VIN, fuel level, check engine status, and the like) are automatically updated to a Inventory Database System (IDS) which, in addition to updating the database or comparing the data to the inventory shown in a DMS (dealer management system), informs the database of the location of the vehicle throughout its life cycle on the dealership premises and upon return to a monitored location after vehicle sale.

Information is retrieved from an IDS via a mobile wireless device (e.g. cellular telephone) by authorized users, e.g. service advisor for service call or sales representative for customer vehicle demonstration. On sold vehicles, customer information is stored on a web centric database retrievable upon return of the customer/vehicle to any connected dealership.

Routine maintenance. Information is retrieved from the wireless device within range of the computer or portal reader upon arrival at the service facility. An employee (sales, service, etc.) is notified that the customer/vehicle is on the business premises. If an appointment was made, e.g. on-line or via customer mobile phone, system executes retrieval of repair order or warranty scheduled order information relating to the vehicle.

If no advance appointment was made, optionally the system still has vehicle information and can better have service representative advise the person of their options for service, reducing service advisor's time because vehicle information automatically has been captured via a computer (hand held device or other) and entered in the DMS system.

### Advantages Over the Prior Art:

allows the dealership to manage existing inventory by reporting alerts, such as low fuel for demonstration ride
reduces the amount of time spent searching for a vehicle for delivery or post-service return to customer
improves inventory management with near real time inventory data, such as verification for on-line consumers searching for vehicles
monitors the movement of the vehicle throughout the service process (intake, service performed, car wash area, customer-ready)
status can be:
   updated directly to the consumer, e.g. via a text message
   accessible on-line
   displayed on a monitor in the waiting room
decreases the amount of time spent on the telephone by service advisors handling customer status inquiries
mechanic's work performance monitored
parts use monitored and associated with repair order
permits customer check in or check out, e.g. via interactive kiosk
permits diagnostic check from site of roadside emergency or breakdown, and dispatch of mechanic and parts needed for possible roadside repair
permits law enforcement the capability to access the ECU and to disable a vehicle
permits tracking of inventory in transit in vehicles, e.g. HAZMAT, alcohol or pharmaceutical contents can be linked to separate IDS systems

As to the last point, many enterprise employees, because of concerns with security, sensitivity and asset value, already have employee identification cards which allow accessibility to facilities and equipment based on their pre-determined roles or permissions granted by enterprise administration. These roles or permissions require some record-keeping, and thus provide entry and exit reports, as well as some level of security, but such systems are not currently used in conjunction with vehicle asset tracking for inventory management.

Thus, in a further aspect, the security of the system can be controlled by verifying the identity of a system user wherein client software identifies users and allows users to be classified into groups, and wherein permissions or roles are assigned to such groups. Various methods for determining identity, and corresponding permissions and roles within the system, are available. For example, security measures may include, but are not limited to, the use of

(a) an identification card,

(b) a personal identification number (“PIN”), and

(c) a biometric identification device.

In another aspect, the method additionally comprises the step of concurrently tracking vehicle cargo in a second inventory database system.

Further, as a law enforcement and homeland security feature, the system could be implemented with a vehicle “kill” routine programmed into the ECU. Law enforcement would have the ability to access the on board ECU to disable the vehicle if the vehicle has been determined to have caused, or be about to cause, a catastrophic event, harm to others, or other sufficiently dangerous or illegal activity.

### EXAMPLES AND EMBODIMENTS OF THE INVENTIVE SUBJECT MATTER

The following examples are illustrative of the inventive subject matter and are not intended to be limitations thereon.

### Example 1

### Exemplary Wireless Device for Tracking and Management

An exemplary Bluetooth or Wi-Fi device has an OBD II interface designed to aid the diagnostics of all vehicles. The OBD II module is designed to provide an interface into, both the OBD port and onto the CAN II interface, providing much more than a simple diagnostic interface. The interface is entirely cable free using a Bluetooth module to wirelessly provide a robust and reliable connection to personal computers, PDA's and mobile phone enabled with Bluetooth.

An exemplary OBD II interface is supplied with diagnostic software (which we could customize to suit our own needs) for personal computers, PDA's and mobile phones, making this module a very versatile diagnostic interface.

Key Features:
Supports all OBD-II compliant vehicles
Bluetooth Class 1 with +6 dBm transmit power (maximum)
Current consumption less than 60 mA (Wi-Fi device currently at 450 mA . . . very power hungry device)
0° C. to +85° C. operating range
Lead free—RoHS compliant
Real time data interface
Supports ISO 9141, KWP2000
Supports SAE J1850
Supports CAN bus

In addition to these features, specifically, an exemplary Wi-Fi device is different in that a small script can be written for it to perform the following: On power up, the device automatically searches and detects the nearest access point (approximately 328 feet (100 m) range). Once located, the device requests an IP address and initiates the authentication process for the module. All the OBD information extracted from any specific or many vehicles could be accessed over the internet from any where around the world.

The OBD II Interface can be paired with a GSM mobile phone to provide an in motion tracking and live diagnostic tool. The data is monitored and passed via the mobile phone to an application, where the vital vehicle telemetric information can be monitored in real time. Combined with live telemetry information with GPS data and the whole system becomes a fleet management tool.

Key Benefits:
Vehicle performance monitoring
Designed for professional use
Can provide a powerful tracking device when matched with GPS data
Deduce the way a vehicle is being driven by driver monitoring
Access data wirelessly from outside of the vehicle
With an in-car Pocket PC or Smartphone you can send OBD information via SMS, WAP or GPRS.

Glossary of Terms

OBD: On Board Diagnostics

SAE J1850: Communications Standard utilized in On- and Off-Road Land-Based Vehicles. Attributes of the J1850 protocol include an open architecture, low cost, master-less, single-level bus topology.

CAN bus: CAN (also referred to as CANbus or CAN bus) is a network used in many every-day products consisting of multiple microcontrollers that need to communicate with each other. CAN is implemented in hardware in microcontrollers of more than 22 chip manufacturers.

GSM: Global System for Mobile

mA: Milli-Amps

ECU: Engine Control Unit

SMS: Short message service

WAP: Wireless Application Protocol

GPRS: General Packet Radio Service (GPRS) is a mobile data service available to users of GSM and IS-136 mobile phones. GPRS data transfer is typically charged per megabyte of transferred data, while data communication via traditional circuit switching is billed per minute of connection time, independent of whether the user has actually transferred data or he has been in an idle state. GPRS can be utilized for services such as WAP access, SMS and MMS, but also for Internet communication services such as email and web access.

### Example 2

### Exemplary Vehicle Dealership and Service Facility

Applicant has found that the inventive subject matter can go beyond rental car agencies and be applied to dealerships and fleet management companies or fleets within companies.

A wireless device is connected to the vehicle (auto/truck) on board ECU that transmits data (e.g. mileage, Vehicle Identification Number (VIN), fuel level and check engine status) to a computer when the vehicle is within a specific distance to the computer or portal reader. Mechanics have for many years utilized a diagnostic tool to retrieve information stored on a vehicles on-board computer in order to determine the reason code for check engine status etc.

There are several key differences in this inventive subject matter as this applies to vehicle management, inventory and remote diagnostic updates utilizing mobile devices as the communication means instead of the satellite such as On Star.

Let's start with vehicle management from the time the new vehicle arrives at a dealership a wireless device is connected to the ECU on board the vehicle. The information of the vehicle's VIN, fuel level, check engine status if any is automatically updated to a Inventory Database System (IDS) which in addition to updating the database or comparing the data to the inventory shown in a DMS (dealer management system) informs the database of the location of the vehicle. The location of the vehicle will be tracked throughout its life cycle on the dealership premises and upon sale.

This information can be retrieved from the IDS from a mobile device (e.g. cellular telephone) by an authorized user such as a service advisor or sales representative when the location of the vehicle is needed to administer a service or retrieve the vehicle for demonstration to a customer.

When the vehicle is sold to a customer the information of the customer is stored on a database for retrieval upon return of the customer to the dealership or for that matter any dealership which is connected to the web centric database. The customer upon returning to a dealership for routine maintenance would be able to drive onto the dealership premises and the information retrieved from the wireless device within range of the computer or portal reader would notify the sales person who made the sale that Ms. Jones has entered the premises, it could retrieve a repair order or warranty scheduled order if the consumer had made an appointment through an on-line web site with the particular dealership. The customer may have not made an on-line appointment but rather was coming in for service and chooses to have a service representative advise the person of their options for service. At this point, the service advisor's time is reduced because the information about the vehicle that is needed to be entered into the DMS system is automatically captured via a computer (hand held device or other).

The advantage of this inventive subject matter allows the dealership to manage its existing inventory in several ways, such as reporting alerts for vehicles that have less than X fuel registered on board to prevent a vehicle from running out of gas on a demonstration ride, to reduce the amount of time spent searching for a vehicle when a customer returns to take delivery, improved inventory management with near real time inventory data for marketing purposes such as verification for on-line consumers searching for vehicles.

The service department will be able to monitor the movement of the vehicle throughout the service process from intake, to service performed to wash rack to customer ready status. This data can be updated to the consumer via a text message or accessible on-line via a website providing near real time data updates which decreases the amount of time spent on the telephone by service advisors handling customer call ins or customers in a waiting room who routinely get up to ask the advisors of the status. The status can be displayed on a monitor in the waiting room with the customer last name and current location of the vehicle should the dealership permit this data from being shared.

A mechanic's work performance would be monitored as to when the vehicle entered the service bay and when the vehicle departed for a test drive (if necessary) this data can also be compared with parts retrieved from the parts department and associated with the service bay if the parts have an RFID tag associated with them or are scanned at the time they are pulled from inventory an assigned to the RO (repair order).

Lot attendants frequently cannot locate vehicles for customers and will have a proximity location of the vehicle prior to searching the sometimes hundreds if not thousands of vehicles in stock.

The goal of this may be to provide a interactive kiosk to allow consumers to check in or check out their vehicle for service.

In addition, this device which is mounted to the vehicle can correspond with an RFID tag associated with the vehicle is applied. This device can permit diagnostic transmission of data to a service advisor when a consumer has called in with a roadside emergency or breakdown. By use of a cellular telephone service advisors or an technician from the dealership or central command center would be able to reach a diagnosis before dispatching a roadside mechanic in the event a part may be required, an so forth.

### Example 3

### Consumer-Driven Vehicle Tracking Example

An exemplary use of the inventive apparatus, systems, methods, and software is an improvement in the existing online vehicle shopping experience for vehicle buyers. Presently, a potential buyer can search for and locate representative vehicle information for particular vehicles, which may or may not accurately represent true dealer stock. In many instances, no verification of an actual vehicle of the type desired is available.

At best, present systems can check for the presence of a unique identifier tag which was at one time associated with a particular vehicle. However, the consumer must still call or visit the dealer to determine whether there is indeed an actual vehicle associated with the tag detected, tags often being removed, and whether the information associated with the tag was correctly entered through what is generally a manual data transfer process. In some instances, the vehicle particulars are incorrect, resulting in consumer disappointment and even anger.

The inventive subject matter, by providing a direct link into the vehicle ECU, resolves all of the deficiencies of the present state of the art. The information contained in the ECU not only identifies the vehicle and provides full descriptive particulars (make, model, year, mileage if any, color, equipment, options, and so forth) when linked to the appropriate database, but further is capable of providing the full service and repair history for a used vehicle. Such information has the dual benefit of improving consumer information and confidence, and reducing dealer sales effort.

It will be readily apparent to one of ordinary skill in the art that the inventive subject matter may require access to the inventory databases of multiple manufacturers, suppliers, distributors, retailers, other sellers, or a combination thereof. With appropriate permissions and roles, multiple individual company databases, shared databases, or both can be searched. In one aspect of the inventive subject matter, such multiple or shared databases are as described in Applicant's U.S. patent application Ser. No. 09/799,879, filed Mar. 7, 2001, now U.S. Pat. No. 6,998,538, issued Feb. 7, 2006, the entire contents of which is hereby incorporated by reference in its entirety.

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the inventive subject matter as described herein.

We claim:

1. An apparatus for collecting information regarding a vehicle, a part thereof, or an owner or operator thereof, comprising a wireless device attached to said vehicle or part thereof, and an interface operably connected to said wireless device and connected to a vehicle electronic control unit; a reading unit wherein said reader reads vehicle information from the vehicle electronic control unit and said interface wirelessly transmits said information to an interface receiver within transmission range from said interface.

2. The apparatus of claim 1, wherein said wireless device is selected from the group consisting of a reader, a host computer, a mobile handheld computer, or an ELS.

3. The apparatus of claim 1, wherein said readers unit and interface operate according to one or more of wireless communications protocols selected from the group consisting of RFID, RuBee, Bluetooth, Wireless USB, Wi-Fi, WiMAX, and ZigBee.

4. The apparatus of claim 1, additionally comprising a biometric identification device.

5. A method for managing vehicles, comprising the steps of:
providing a wireless device connected to the electronic control unit of a vehicle and capable of collecting vehicle information from said electronic control unit and transmitting said information;
collecting information regarding said vehicle from said electronic control unit;
transmitting said vehicle information to a reader, host computer, mobile handheld computer, or ELS within transmission range from said wireless device;
processing said vehicle information in an inventory database system, wherein said inventory database system stores said vehicle information in a database;
permitting access to said vehicle information database to a plurality of authorized system users;
tracking the movement of said vehicle via one or more readers; and
managing a vehicle service or maintenance event based on said vehicle information.

6. The method of claim 5, additionally comprising the step of verifying the identity of a system user with the use of
a. an identification card,
b. a personal identification number (“PIN”), or
c. a biometric identification device.

7. The method of claim 5, additionally comprising the step of concurrently tracking vehicle cargo in a second inventory database system.
